(19) United States
(12) Patent Application Publication
(10) Pub. No.: US 2004/0142600 A1
(43) Pub. Date: Jul. 22, 2004

(54) Docking station and method of operation

(76) Inventor: Kristofer Erik Metz, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/348,404

(22) Filed: Jan. 21, 2003

(51) Int. Cl. H01R 25/00

(52) U.S. Cl. 439/638

(57) ABSTRACT

A docking station comprising a housing adapted to fit within a PCMCIA chamber of a host computer, a bus interface disposed on a first portion of the housing, the bus interface operative for connecting to a power source available from a bus accessible within the chamber, and a connector disposed on a second portion of the housing and in electrical communication with the bus interface to provide access from the power source to a peripheral device when the peripheral device is connected to the connector and the bus interface is engaged with the bus.

### BACKGROUND OF THE INVENTION

Numerous devices exist that have a self contained power source such as a battery and which may be used with computers, particularly laptop computers and other portable electronic instruments. Such devices include a pointing device such as a computer mouse, or a specialized electronic device such as an MP3 player. One problem with such devices is that it is often inconvenient to provide or to access a power source for recharging the device's battery.

For example, a user may wish to recharge a discharged mouse while using a laptop at a remote location (e.g. on an airplane). However, no convenient outlet may exist from which to draw the recharging power for the mouse. Further, such recharging equipment is often bulky and inconvenient to carry and connect with the device. Alternative mechanisms are desired.

### SUMMARY OF THE INVENTION

A docking station comprising a housing adapted to fit within a PCMCIA chamber of a host computer, a bus interface disposed on a first portion of the housing, the bus interface operative for connecting to a power source available from a bus accessible within the chamber, and a connector disposed on a second portion of the housing and in electrical communication with the bus interface to provide access from the power source to a peripheral device when the bus interface is engaged with the bus.

### BRIEF DESCRIPTION OF THE DRAWINGS

FIG. 1 is a perspective view of a system according to an embodiment of the present invention;

FIG. 2 is perspective view of a docking station and a dockable device according to an embodiment of the present invention;

FIG. 3 is a block diagram of a basic architecture of an exemplary a docking station connected to a host computer according to an embodiment of the present invention;

FIG. 4 is a perspective view in partial cutaway of a docking station docked within a PCMCIA chamber of a host computer according to an embodiment of the present invention;

FIG. 5 is a perspective view of a docking station docked within a PCMCIA chamber of a host computer and with a peripheral device according to an embodiment of the present invention;

FIG. 6 illustrates operation of the system according to an embodiment of the present invention; and

FIG. 7 is a block diagram of a basic architecture of an exemplary a docking station connected to a host computer according to another embodiment of the present invention.

### DETAILED DESCRIPTION OF THE PREFERRED EMBODIMENT

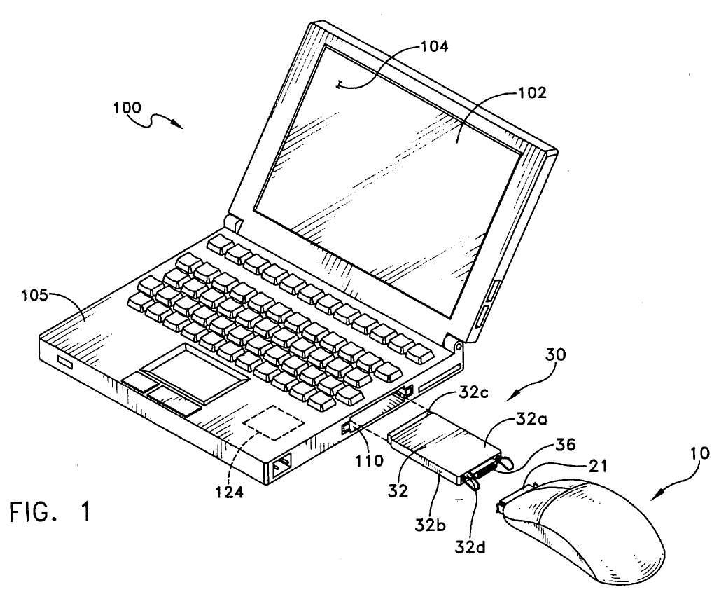

FIG. 1 illustrates an exemplary general-purpose computer implemented as a laptop or notebook host computer 100 comprising a display portion 102 and a base 105 containing a processor (e.g. a CPU), memory, and bus structure (not shown). Base 105 of computer 100 further includes at least one Personal Computer Memory Card International Association (PCMCIA) slot or chamber 110. In general, PCMCIA slots allow electrical communication to be established between the computer and external communication systems. PCMCIA guidelines define three types of cards and sockets for support of electronic equipment. PCMCIA standards require all PC cards to have the same length and width (roughly the size of a credit card), and each card includes a connector to allow it to be connected to the computer host device. In particular, according to known PCMCIA standards, PC cards have a length of 85.6 mm (3.4 inches), a width of 54.0 mm (2.1 inches), and a height of 3.3 mm (0.1 inches), 5.0 mm (0.2 inches) or 10.5 mm (0.4 inches) depending upon if the card is a Type I card, Type II card or Type III card, respectively. However, as many portable computers include built-in LAN and modem ports, the need for a user to use the PCMCIA slots for such connectivity has been greatly reduced.

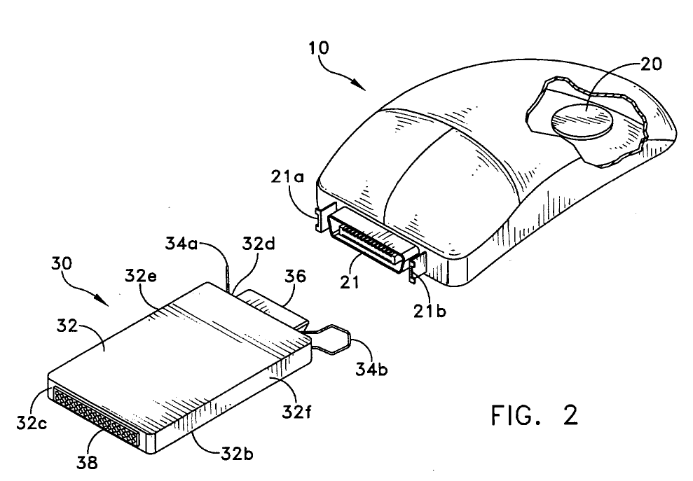

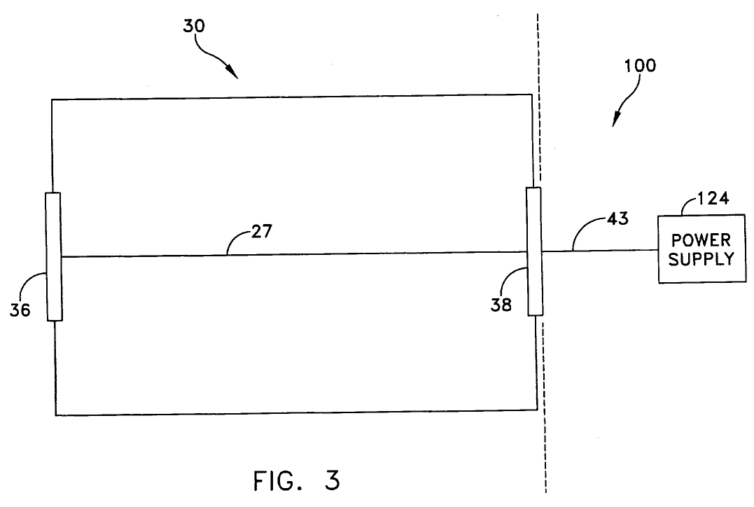

In accordance with an aspect of the present invention, a docking station 30 has a housing 32 configured in the shape of a card to be removably inserted into the PCMCIA chamber 110 and includes connections for establishing a communications path from host computer 100 to a peripheral electronic device 10 such as a computer mouse. In an exemplary embodiment, housing 32 of docking station or docking card 30 comprises substantially planar top and bottom surfaces 32a, 32b, side surfaces 32e, 32f (FIG. 2), and lateral front and rear surfaces 32c, 32d that define first and second ends of the housing, respectively. The housing is dimensioned to fit within a PCMCIA Type II form factor so as to be insertable into (and removable from) corresponding PCMCIA Type II chamber 110 in host computer 100. A bus interface connector 38 is disposed on lateral front surface 32c of housing 32 and electrically coupled to connector 36 on lateral rear surface 32d of the docking station housing, as shown in FIGS. 2 and 3. A bus structure 43 (FIG. 3) disposed within base 105 of computer 100 is operatively connected to a power supply 124 for supplying power to the host computer. Bus 43 may also be configured to provide one or more data, control, and power pathways, or combinations thereof. PCMCIA chamber 110 formed in base 105 is configured such that bus 43 is accessible via the chamber 110, e.g. via a socket or pin connection within the chamber.

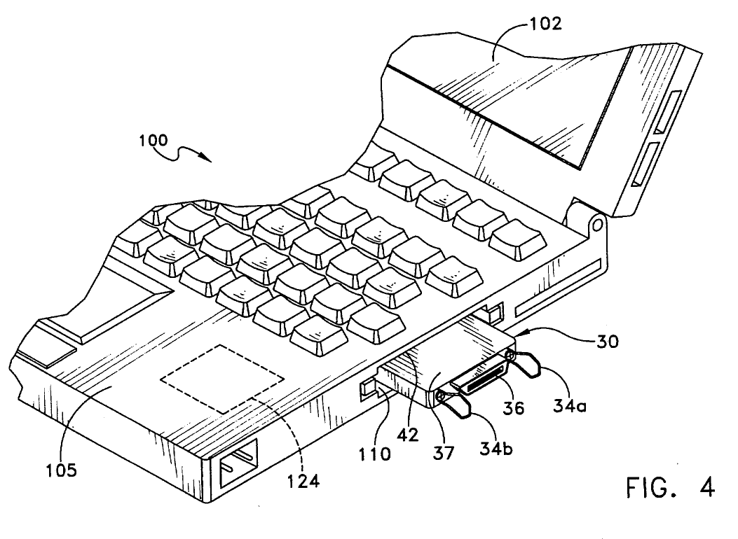

In an exemplary embodiment, when the docking station housing 32 is inserted within chamber 110, bus interface connector 38 matingly engages the PCMCIA socket to which the bus 43 (FIG. 3) is connected to provide an electrical interface or pathway for obtaining power from power supply 124 within computer 100. FIG. 3 illustrates the basic architecture and electrical connectivity between the host computer 100 and docking card 30 for providing a power pathway via bus interface connector 38 and peripheral device connector 36 when the docking card is inserted and seated in the PCMCIA chamber. FIG. 4 illustrates a perspective view of the docking card 30 when docked within the host computer PCMCIA chamber. In an exemplary embodiment shown in FIG. 4, at least a portion of housing 32 remains exposed outside PCMCIA chamber 110 when housing 32 is inserted and seated within the PCMCIA chamber. More particularly, when inserted and seated into the PCMCIA chamber, the docking card has a length such that a portion 37 of the card, including the connector 36 on the lateral rear surface of the docking card, extends a predetermined distance outward from the aperture 42 of the PCMCIA chamber to enable connection with peripheral device 10.

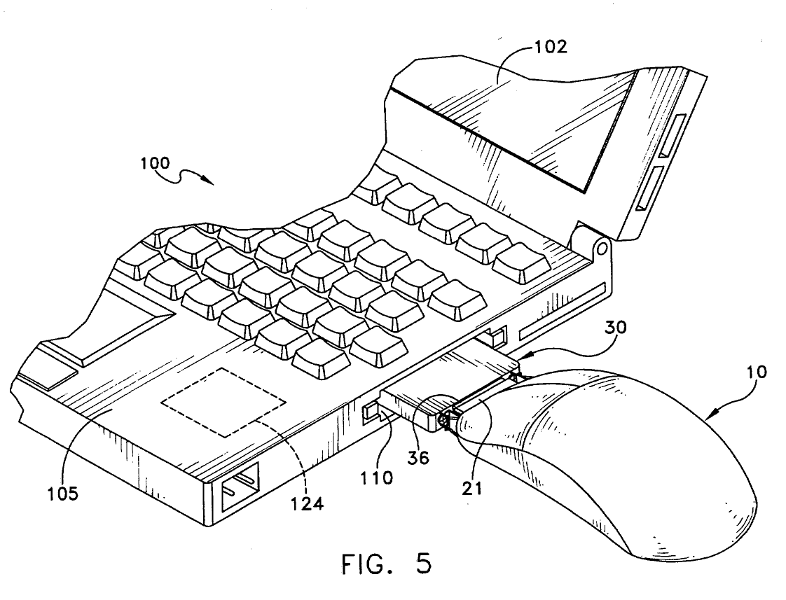

Connector 36 is configured to electrically connect (i.e. dock) to a compatible conductive contact region implemented in recharging connector 21 of peripheral device 10 as shown in FIGS. 2 and 5. When docked with docking card 30, a rechargeable battery 20 housed within device 10 may be charged via the power supply 124 of the host computer. In the exemplary embodiment shown in FIGS. 2 and 5, the peripheral device is illustrated as a wireless, optical computer mouse having rechargeable battery 20 and capable of wireless communications with an appropriately configured receiver (not shown) in host computer 100. However, it is understood that the peripheral device may comprise any number of peripheral devices, including for example, hand-held input devices such as palm top type handheld devices, personal digital assistants (PDAs), specialized MP3 devices, and the like.

In the exemplary embodiment shown in FIG. 2, connector 36 is disposed about rear surface 32d of housing 32. Connector 36 is operatively in communication with bus interface 38 to operatively connect the power interface to recharging connector 21 of device 10. Recharging connector 21 provides a physical interface to the power pathway to access the power source of host computer 100 (FIG. 1). Although shown on a leading edge of device 10 in FIG. 2, recharging connector 21 may be disposed at any convenient position about device 10. Further, such connection may be accomplished via a power port which may be a portion of connector 36, to provide a source of power to device 10 when device 10 is connected to connector 36 and housing 32 is inserted and seated within chamber 110. In this manner, when device 10 is docked at docking card 30, re-chargeable power source (i.e. battery 20) in device 10 may draw power from and become charged via the host computer power source.

Additionally, connector 36 may provide operational access to bus 43 (FIG. 2) for one or more devices in docking station 30, device 10, or a combination thereof. That is, a portion of connector 36 (e.g. one of more contacts or pins) may be utilized to operatively connect with corresponding contacts of bus interface connector 38 to provide a functional pathway for bus data and/or control signals to and/or from the bus and the peripheral device

While the exemplary embodiment of FIG. 2 shows bus interface connector 38 contacts disposed at front surface 32c for insertion into PCMCIA chamber 110, contacts may also be disposed along one or more sides of the housing 32 (e.g. contact rails) for corresponding electrical contact with the bus interface to enable electrical communication with the host computer power supply 124. Further, one or more releasable latches, shown as 34a and 34b, may be disposed at the second end of housing 32. Latches 34a, 34b are capable of removably securing device 10 to the rear surface 32d, connector 36, or a combination thereof. For example, device 10 may have mating ends 21a, 21b which may be used with latches 34a,34b to aid in securing device 10 to docking card 30.

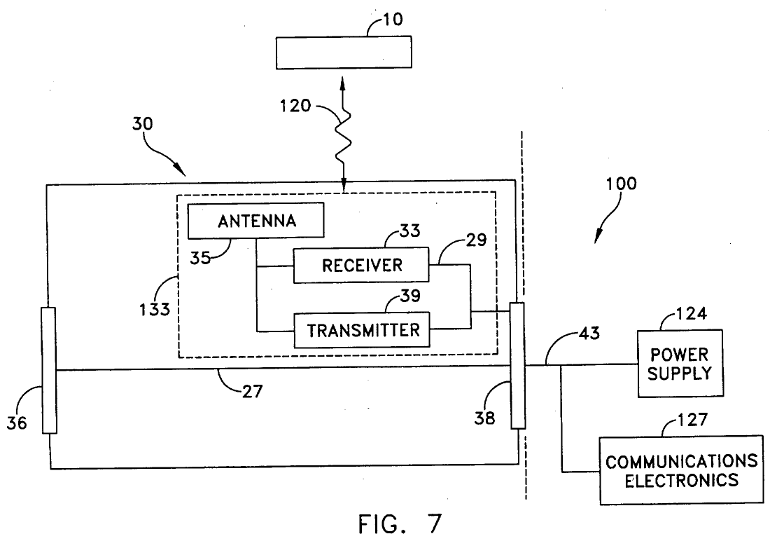

FIG. 7 shows another embodiment of a basic architecture according to an aspect of the invention wherein docking card 30 further includes a wireless communications module 133 including a receiver 33 for receiving wireless communications from a wireless peripheral device for communication to host computer 100. In this embodiment, a communication system 120 such as a wireless telecommunications system, operatively couples the peripheral device 10 to computer 100 via the docking card to enable transfer of data such as positional information for a wireless mouse to the host computer via lead line 29 for controlling movement of a display reference such as cursor 104 (FIG. 1). Wireless communications module 133 may be disposed within housing 32 and adapted to receive a transmission from a wireless transmitter such as may be present in device 10. Module 133 may be, for example, an Infrared Data Association (IrDA) type receiver, a BLUETOOTH™ receiver, an IEEE 802.11b receiver, or the like configured to receive a wireless communication from an appropriately configured transmitter on the peripheral device. Receiver 33 may receive and pass the information transmitted from peripheral device 10 to computer 100 such as via driver software in operative communications with communication system 120. Computer 100 may analyze the received information and make the analyzed received information available for use by other software, e.g. application software for processing and display. Wireless communications module 133 may further comprise a transceiver (i.e. transmitter 39 and receiver 33 arrangement) and may further include an antenna 35 disposed about the housing for use with wireless communications systems such as BLUETOOTH™ for bidirectional communication of data information between the host computer and the peripheral input device. In this manner, appropriate electronic circuitry housed within the docking station enables wireless communications to be accomplished in the docking station and transmitted to the computer rather than having such connectivity directly between the host computer and the peripheral device.

As shown in FIG. 7 bus interface connector 38 is adapted to provide power through a power interface portion via lead line 27 (e.g. one or more pins or contacts of connector 38) and bus 43 accessible within PCMCIA chamber 110 (FIG. 2). Host computer power supply 124 is operatively connected to bus 43 so as to provide such a power pathway when the docking card is engaged within PCMCIA chamber 110. Bus interface connector 38 may be used solely to provide access to the power interface or additionally act as a communications interface via lead line 29 to provide unidirectional or bi-directional data communication between communications electronics 127 of host computer 100 via bus 43, and one or more devices in docking station 30, device 10, or a combination thereof.

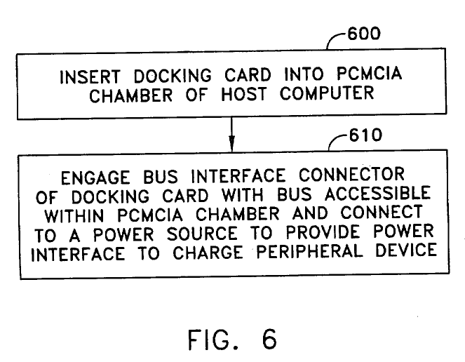

In the operation of an exemplary embodiment, as shown in FIG. 6, docking card housing 32 (FIG. 1) may be inserted (step 600) into Type II PCMCIA chamber 110 (FIG. 1) of host computer 100 (FIG. 1) via aperture 42 (FIG. 4). Bus 43 operatively engages bus interface connector 38 (FIG. 3) when housing 32 is disposed a predetermined distance into chamber 110. When bus 43 operatively engages bus interface connector 38, power may be provided from a power source accessible through bus 43 to connector 36 for access by a peripheral device 10 via an appropriately configured connector 21 on device 10 (FIG. 2) for charging the device's battery (step 610).

A communications pathway from receiver 33 of the docking card (FIG. 7) and bus 43 allows communications data access to and/or from host computer 100 to device 10.

It will be understood that various changes in the details, materials, and arrangements of the parts which have been described and illustrated above in order to explain the nature of this invention may be made by those skilled in the art without departing from the principle and scope of the invention as recited in the appended claims.

We claim:

1. A docking station, comprising:
a housing adapted to fit within a PCMCIA chamber of a host computer;
a bus interface disposed on a first portion of the housing, the bus interface operative for connecting to a power source available from a bus accessible within the chamber; and
a connector disposed on a second portion of the housing and in electrical communication with the bus interface to provide access from the power source to a peripheral device when the bus interface is engaged with the bus.

2. The docking station according to claim 1, further comprising a releasable latch capable of temporarily securing the peripheral device to the docking station.

3. The docking station according to claim 1, further comprising a receiver adapted to receive a transmission from a wireless transmitter.

4. The docking station according to claim 3, wherein the receiver comprises an antenna.

5. The docking station according to claim 3, wherein the receiver is at least one of an (i) IrDA receiver, (ii) a BlueTooth receiver, and (iii) an IEEE 802.11b receiver.

6. The docking station according to claim 3, further comprising a transmitter for wirelessly transmitting a communications signal from the docking station.

7. The docking station according to claim 1, wherein the housing is adapted to fit within a Type II PCMCIA chamber.

8. The docking station according to claim 1, wherein the second portion of the housing on which the connector is disposed extends a predetermined distance out from the PCMCIA chamber for connecting with the peripheral device when the bus interface is engaged with the bus.

9. A computer system, comprising:
a computer having a base, a processor and a bus;
a PCMCIA chamber formed in the base through which a portion of the bus is accessible; and
a removable docking station comprising:
a housing adapted to fit within the PCMCIA chamber;
a bus interface disposed about a first end of the housing to mate with the bus; and
a connector disposed about a second end of the housing for connection with a peripheral device, the connector operatively in communication with the bus interface to provide at least one of (i) a source of power to the peripheral device when the peripheral device is connected to the connector and (ii) a functional pathway for bus signals between the bus and the peripheral device.

10. The computer system according to claim 9, further comprising a releasable latch capable of removably securing the peripheral device to the docking station.

11. The computer system according to claim 9, further comprising a communication system at least partially disposed within the housing, the communication system operatively coupling the peripheral device to the computer.

12. The computer system according to claim 9, wherein the communication system comprises a receiver adapted to receive a transmission from a wireless transmitter.

13. The computer system according to claim 12, wherein the communication system further comprises an antenna disposed about the housing, the antenna operatively in communication with the receiver.

14. The computer system according to claim 12, wherein the communication system comprises at least one of an (i) IrDA communication system, (ii) a BlueTooth communication system, and (iii) an IEEE 802.11b communication system.

15. The computer system according to claim 9, wherein the PCMCIA chamber is a Type II PCMCIA chamber; and the housing is adapted to fit within the Type II PCMCIA chamber.

16. The computer system according to claim 9, wherein the peripheral device comprises a computer mouse.

17. A method for docking a computer to a docking station, in which the computer has a PCMCIA chamber through which a portion of a bus is accessible, the bus operatively communicating with a power supply within the computer for providing a power pathway, the method comprising:
inserting a docking station having a housing sized and shaped in the form of a PCMCIA card compatible with the PCMCIA chamber into the PCMCIA chamber, such that a first end of the housing on which is disposed a bus interface connector mates with a corresponding connection in the PCMCIA chamber in electrical communication with the bus, the docking station housing further comprising a peripheral connector disposed near a second end of the housing and in electrical communication with the bus interface connector, whereby the peripheral connector is accessible to a peripheral device for providing a power pathway to the host computer.

18. The method according to claim 17, further comprising connecting the peripheral device to the peripheral connector to establish the power pathway between the host computer and the peripheral device.

19. The method according to claim 17, wherein the PCMCIA chamber is a Type II PCMCIA chamber.

20. The method according to claim 17, further comprising removably latching the peripheral device to the peripheral connector.

21. The method according to claim 17, further comprising providing a communications pathway in the housing for a wireless device.

22. The method according to claim 17, further comprising providing communications access between the bus and the device using at least one of (i) a functional unidirectional pathway and (ii) a functional bidirectional pathway.

23. A docking station comprising:
a housing adapted to fit within a PCMCIA chamber of a host computer;
first means coupled to said housing for connecting to a power source accessible via the chamber; and
second means coupled to said housing and in electrical communication with said first means for providing access from the power source to a peripheral device when said first means is in electrical communication with said power source.

24. The docking station according to claim 23, further comprising means for releasably securing the peripheral device to the docking station.

25. The docking station according to claim 23, further comprising means formed in said housing for receiving a transmission from a wireless transmitter.

26. The docking station according to claim 25, further comprising means formed in said housing for wirelessly transmitting a communications signal from said docking station.

27. The docking station according to claim 23, wherein the housing is adapted to fit within a Type II PCMCIA chamber.

28. The docking station according to claim 23, wherein said second means extends a predetermined distance out from the PCMCIA chamber.
